(19) United States
(12) Patent Application Publication
(10) Pub. No.: US 2016/0239387 A1
(43) Pub. Date: Aug. 18, 2016

(54) Operation synchronization method, device and storage medium

(71) Applicant: Tencent Technology (Shenzhen) Company Limited, Shenzhen (CN)

(72) Inventors: Hongcheng Fu, Shenzhen (CN); Guohua Liu, Shenzhen (CN); Qing Zhang, Shenzhen (CN)

(21) Appl. No.: 15/140,015

(22) Filed: Apr. 27, 2016

Related U.S. Application Data
(63) Continuation of application No. PCT/CN2014/081394, filed on Jul. 1, 2014.

(30) Foreign Application Priority Data
Oct. 28, 2013 (CN) 201310515956.0

(51) Int. Cl. G06F 11/14; G06F 17/24; G06F 17/30

(52) U.S. Cl. CPC G06F 11/1451; G06F 17/30581; G06F 17/30368; G06F 17/24; G06F 17/30038

(57) ABSTRACT

The present application discloses an operation synchronization method and device, and a storage medium, which belong to the field of network technologies. The method includes: when an editing operation of a first terminal on multimedia resource information is received, executing the editing operation on the multimedia resource information; querying data connection information corresponding to account information used by the first terminal; determining whether the queried data connection information comprises data connection information of a second terminal; when the queried data connection information comprises the data connection information of the second terminal, synchronizing the editing operation on the multimedia resource information to the second terminal. According to the present application, when an editing operation of a first terminal on multimedia resource information is received, data connection information corresponding to the account information used by the first terminal is queried, and when the queried data connection information includes data connection information of a second terminal, the editing operation is synchronized to the second terminal, thus implementing real-time synchronization of multimedia resource information of different terminals.

This is a continuation application of International Patent Application No. PCT/CN2014/081394, filed on Jul. 1, 2014, which claims priority to Chinese Patent Application No. 201310515956.0 filed on Oct. 28, 2013, the disclosure of which is incorporated by reference herein in its entirety.

### TECHNICAL FIELD

The disclosure relates to the field of network technologies, particularly to an operation synchronization method, device and a storage medium.

### BACKGROUND

With the development of network technologies, a user may login the same multimedia application, for example, a webpage or software, on different terminals so as to download a multimedia file, bookmark the multimedia file, add the multimedia file to a playlist, and play the multimedia file.

Taking a song application for example, the user adds a song to a playlist on a terminal, and then the user may also use a refreshing operation to also add the song to a playlist when logging in the song application on another terminal, thus synchronizing the playlists of the song application in the two terminals.

However, the user needs to login the multimedia application on the terminal and executes the refreshing operation during the synchronizing process, which cannot implement real-time synchronization between different terminals, thus resulting in poor real-time performance and cumbersome operations.

### SUMMARY

For the above, the disclosure provides an operation synchronization method and device and a storage medium. The technical solutions are as follows.

In a first aspect, there is provided an operation synchronization method. The method includes that:

when an editing operation of a first terminal on multimedia resource information is received, the editing operation is executed on the multimedia resource information;

data connection information corresponding to account information used by the first terminal is queried;

whether the queried data connection information includes data connection information of a second terminal is determined, and

When the queried data connection information includes the data connection information of the second terminal, the editing operation on the multimedia resource information is synchronized to the second terminal.

In a second aspect, there is provided an operation synchronization device. The device includes:

an operation receiving module configured to execute, when receiving an editing operation of a first terminal on multimedia resource information, the editing operation on the multimedia resource information;

a connection information query module, configured to query data connection information corresponding to account information used by the first terminal;

a determining module, configured to determine whether the queried data connection information includes data connection information of a second terminal, and

a synchronizing module, configured to synchronize, when the queried data connection information includes the data connection information of the second terminal, the editing operation on the multimedia resource information to the second terminal.

In a third aspect, there is provided a storage medium containing computer executable instructions. The computer executable instructions are used for executing an operation synchronization method when being executed by a computer processor. The method includes:

when an editing operation of a first terminal on multimedia resource information is received, the editing operation is executed on the multimedia resource information;

data connection information corresponding to account information used by the first terminal is queried;

whether the queried data connection information includes data connection information of a second terminal is determined, and

When the queried data connection information includes the data connection information of the second terminal, the editing operation on the multimedia resource information is synchronized to the second terminal.

The technical solutions provided by the embodiments of the disclosure have brought the following beneficial effect.

According to a method, a device and a storage medium provided by the embodiments of the disclosure, when an editing operation of a first terminal on multimedia resource information is received, data connection information corresponding to account information used by the first terminal is queried; when the queried data connection information includes data connection information of a second terminal, the editing operation is synchronized to the second terminal, thus implementing real-time synchronization of multimedia resource information of different terminals, good real-time performance, and simple and convenient operations.

### BRIEF DESCRIPTION OF THE DRAWINGS

In order to describe the technical solutions in the embodiments of the disclosure more clearly, the accompanying drawings that need to be used in the description of the embodiments will be introduced simply hereinafter. Obviously, the accompanying drawings in the following description are only some embodiments of the disclosure, and other accompanying drawings may be further obtained based on these accompanying drawings by those of ordinary skill in the art without any creative efforts.

FIG. 1 is a flowchart of an operation synchronization method provided by an embodiment of the disclosure;

FIG. 2a is a flowchart of an operation synchronization method provided by an embodiment of the disclosure;

FIG. 2b is a schematic diagram of a synchronization system framework provided by an embodiment of the disclosure;

FIG. 2c is a flowchart of creating a long connection between a proxy server and a terminal according to an embodiment of the disclosure;

FIG. 3 is a structural diagram of an operation synchronization device provided by an embodiment of the disclosure; and

FIG. 4 is a structural diagram of a server provided by an embodiment of the disclosure.

### DETAILED DESCRIPTION

The technical solutions in the embodiments of the disclosure will be described clearly and completely in conjunction with the accompanying drawings hereinafter. Obviously, the described embodiments are only some embodiments, rather than all embodiments of the disclosure, and are used for elaborating the principles of the disclosure, instead of limiting the disclosure to these specific embodiments. All other embodiments obtained based on the embodiments in the disclosure by those of ordinary skill in the art without creative efforts fall within the scope of protection of the disclosure.

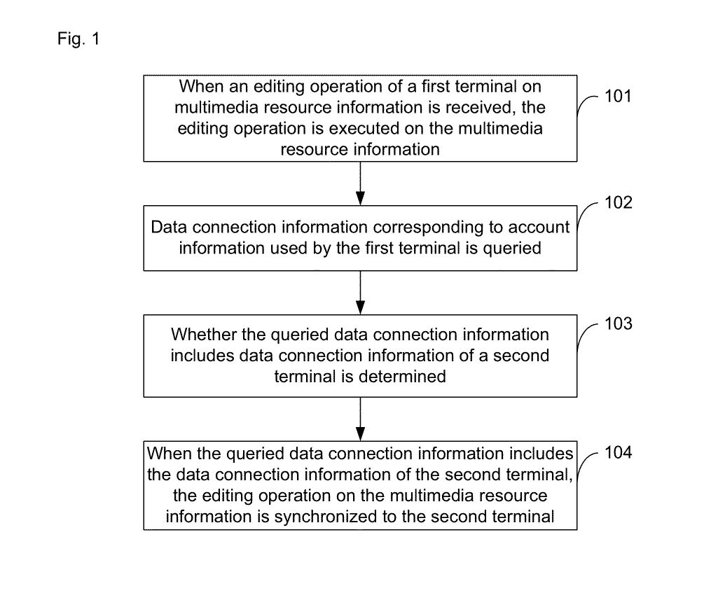

FIG. 1 is a flowchart of an operation synchronization method provided by an embodiment of the disclosure. The embodiment may be applied in a system framework consisting of a server and at least one terminal, wherein the at least one terminal is equipped with software associated with the server or such an application as a website service. For example, the application is a community, a network disk, a multimedia application and so on. Data communication may be performed between the at least one terminal and the server through a long connection or a short connection. Different terminals may login the same account information to instruct the server to provide the same application service to these terminals. The embodiment of the disclosure may be applicable to synchronization of an editing operation of a terminal corresponding to account information on multimedia resource information to other terminals corresponding to the account information. A major executive body of the embodiment of the disclosure is the server. Referring to FIG. 1, the method includes:

Step 101: when an editing operation of a first terminal on multimedia resource information is received, executing the editing operation on the multimedia resource information.

Step 102: querying data connection information corresponding to account information used by the first terminal.

Step 103: determining whether the queried data connection information comprises data connection information of a second terminal.

Step 104: when the queried data connection information comprises the data connection information of the second terminal, synchronizing the editing operation on the multimedia resource information to the second terminal.

According to the method provided by the embodiment of the disclosure, when the editing operation of the first terminal on the multimedia resource information is received, the data connection information corresponding to the account information used by the first terminal is queried; When the queried data connection information includes the data connection information of the second terminal, the editing operation is synchronized to the second terminal, thus implementing real-time synchronization of multimedia resource information of different terminals, good real-time performance, and simple and convenient operations.

Optionally, after the editing operation of the first terminal on the multimedia resource information is received, the method further includes:

whether the editing operation on the multimedia resource information satisfies a preset synchronization condition is determined, and when the editing operation on the multimedia resource information satisfies the preset synchronization condition, executing the step of querying the data connection information corresponding to the account information used by the first terminal.

Optionally, the step of when the queried data connection information comprises the data connection information of the second terminal, synchronizing the editing operation on the multimedia resource information to the second terminal:

when the queried data connection information comprises the data connection information of the second terminal, determining whether the second terminal allows to perform synchronization, and when the second terminal allows to perform synchronization, executing the step of synchronizing the editing operation on the multimedia resource information to the second terminal; or

when the queried data connection information comprises the data connection information of the second terminal, determining whether a data connection type of the second terminal is a preset connection type according to the data connection information of the second terminal, and when the data connection type of the second terminal is the preset connection type, executing the step of synchronizing the editing operation on the multimedia resource information to the second terminal.

Optionally, the multimedia resource information is a playlist, and synchronizing the editing operation on the multimedia resource information to the second terminal comprises:

when the editing operation on the multimedia resource information is to create a new playlist, creating the new playlist on the second terminal; or

when the editing operation on the multimedia resource information is to delete a playlist, deleting the playlist on the second terminal; or

when the editing operation on the multimedia resource information is to rename a playlist, acquiring a new name of the playlist on the first terminal, and renaming the playlist on the second terminal as the new name; or

when the editing operation on the multimedia resource information is to add note information to a playlist, adding the same note information to the playlist on the second terminal; or

when the editing operation on the multimedia resource information is to add a multimedia file to a playlist, adding the multimedia file to the playlist on the second terminal; or

when the editing operation on the multimedia resource information is to delete a multimedia file from a playlist, deleting the multimedia file from the playlist of the second terminal; or

when the editing operation on the multimedia resource information is to move a multimedia file from a first playlist to a second playlist, moving the multimedia file from the first playlist to the second playlist on the second terminal.

Optionally, the multimedia resource information is at least one multimedia file in a playlist, and synchronizing the editing operation on the multimedia resource information to the second terminal comprises:

when the editing operation on the multimedia resource information is to download a multimedia file, downloading the multimedia file to the second terminal; or

when the editing operation on the multimedia resource information is to delete a multimedia file, deleting the multimedia file in the second terminal; or

when the editing operation on the multimedia resource information is to rename a multimedia file, acquiring a new name of the multimedia file on the first terminal, and renaming the multimedia file on the second terminal as the new name; or

when the editing operation on the multimedia resource information is to add note information to a multimedia file, adding the same note information to the multimedia file on the second terminal; or

when the editing operation on the multimedia resource information is to modify note information for a multimedia file, modifying the note information of the multimedia file in the same manner on the second terminal; or

when the editing operation on the multimedia resource information is to move a multimedia file from a first folder to a second folder, moving the multimedia file from the first folder to the second folder on the second terminal.

Optionally, the multimedia resource information is a favorites list, and synchronizing the editing operation on the multimedia resource information to the second terminal comprises:

when the editing operation on the multimedia resource information is to create a new favorites list, creating the new favorites list on the second terminal; or

when the editing operation on the multimedia resource information is to delete a favorites list, deleting the favorites list on the second terminal; or

when the editing operation on the multimedia resource information is to rename a favorites list, acquiring a new name of the favorites list on the first terminal, and renaming the favorites list on the second terminal as the new name; or

when the editing operation on the multimedia resource information is to add note information to a favorites list, adding the same note information to the favorites list on the second terminal; or

when the editing operation on the multimedia resource information is to modify information of a multimedia file in a favorites list, modifying the information of the multimedia file in the favorites list in the same manner on the second terminal; or

when the editing operation on the multimedia resource information is to add a multimedia file to a favorites list, adding the multimedia file to the favorites list on the second terminal; or

when the editing operation on the multimedia resource information is to delete a multimedia file from a favorites list, deleting the multimedia file from the favorites list on the second terminal; or

when the editing operation on the multimedia resource information is to move a multimedia file from a first favorites list to a second favorites list, moving the multimedia file from the first favorites list to the second favorites list on the second terminal.

Optionally, the multimedia resource information is an interest list for following information of a designated source, and synchronizing the editing operation on the multimedia resource information to the second terminal comprises:

when the editing operation on the multimedia resource information is to create a new interest list, creating the new interest list on the second terminal; or

when the editing operation on the multimedia resource information is to delete an interest list, deleting the interest list on the second terminal; or

when the editing operation on the multimedia resource information is to rename an interest list, acquiring a new name of the interest list on the first terminal, and renaming the interest list on the second terminal as the new name; or

when the editing operation on the multimedia resource information is to add note information to an interest list, adding the same note information to the interest list on the second terminal; or

when the editing operation on the multimedia resource information is to modify information of a multimedia file in an interest list, modifying the information of the multimedia file in the interest list in the same manner on the second terminal.

Optionally, the method further includes:

when a login request carrying the account information of the first terminal is received, creating a data connection with the first terminal;

acquiring a terminal identifier of the first terminal; and

generating data connection information corresponding to the terminal identifier of the account information and using the data connection information as data connection information corresponding to the first terminal of the account information.

Optionally, acquiring the terminal identifier of the first terminal comprises:

using a terminal number of the first terminal as the terminal identifier of the first terminal; or

allocating an identifier as the terminal identifier of the first terminal.

Optionally, the method further includes:

acquiring a characteristic value of the account information;

querying, according to the characteristic value, pre-created corresponding relations between characteristic values and connection databases, and determining a connection database corresponding to the account information; and

saving the data connection information corresponding to the first terminal of the account information in the connection database corresponding to the account information.

Optionally, querying the data connection information corresponding to the account information used by the first terminal comprises:

querying the data connection information corresponding to the account information in the connection database corresponding to the account information. All optional technical solutions above may be randomly combined to form optional embodiments of the disclosure, which will not be described repeatedly here.

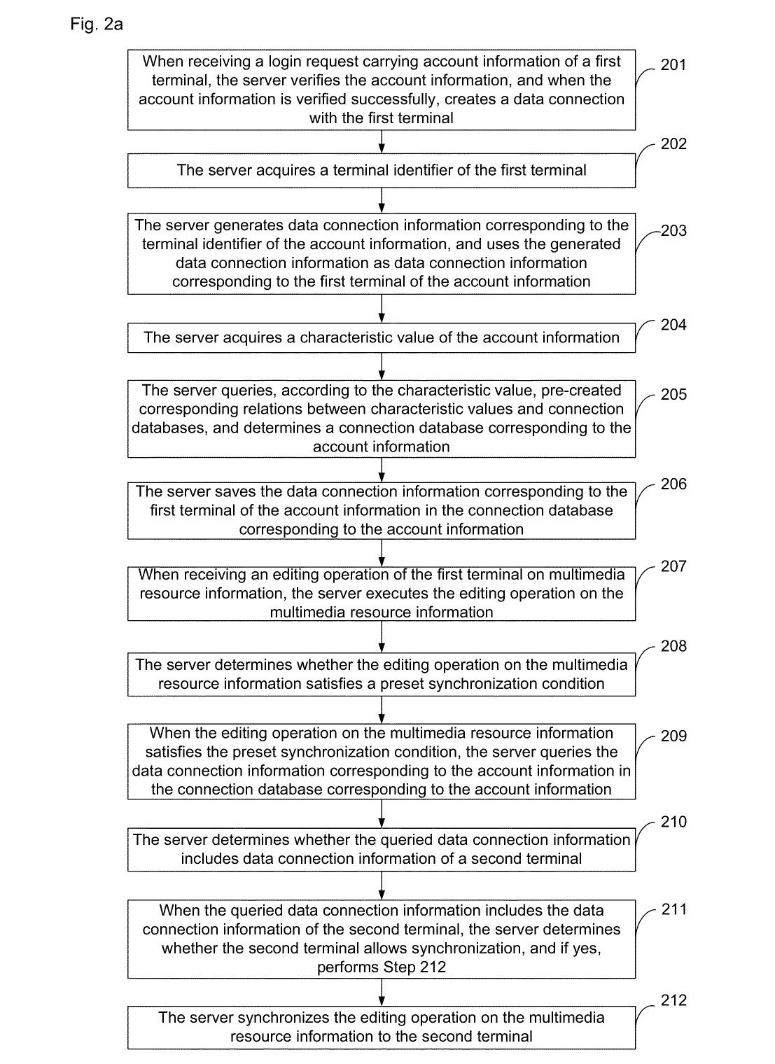

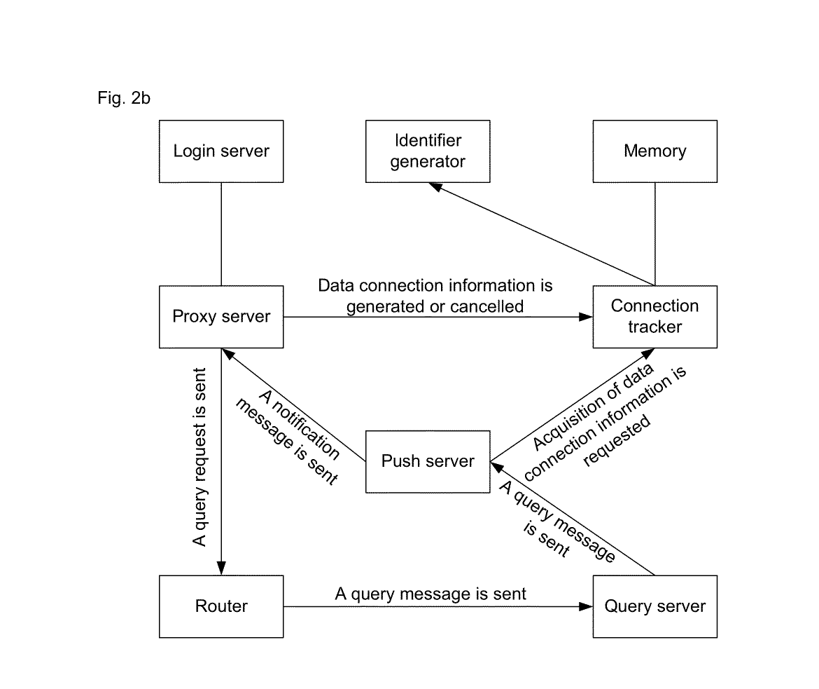

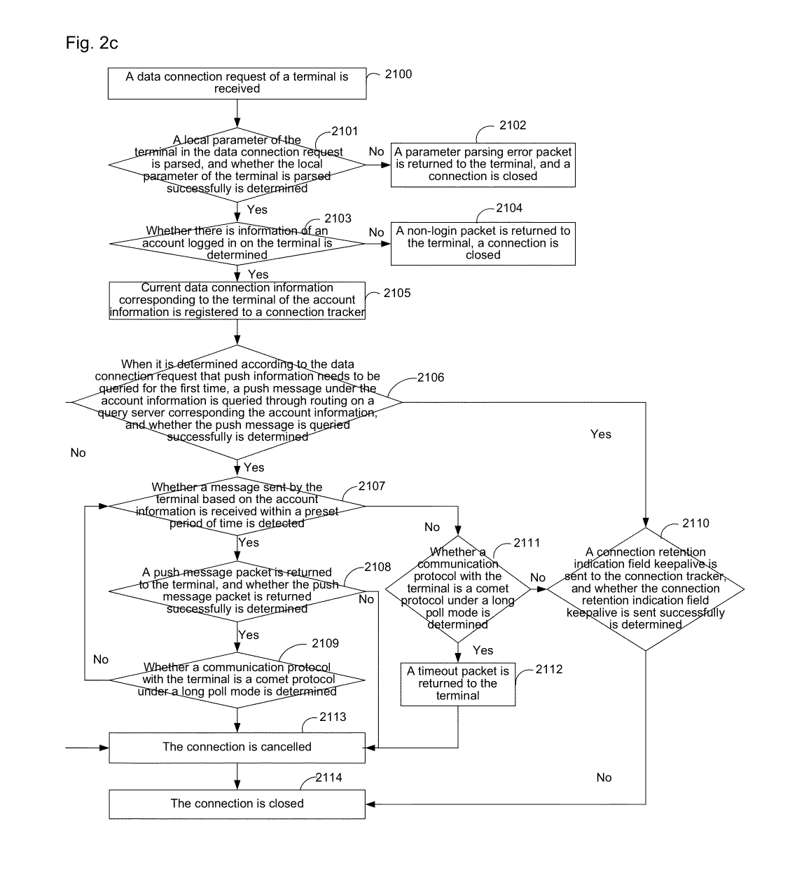

FIG. 2a is a flowchart of an operation synchronization method provided by an embodiment of the disclosure. The present embodiment provides a preferred embodiment based on the embodiment above.

The embodiment of the disclosure may be applied to such an application scenario that when a user uses different terminals to access an application associated with a server, the server creates data connections with the terminals that access the application so as to provide a service including information display, file downloading and so on to the terminals that access the application, wherein the application associated with the server may refer to software or a website service. For example, application associated with the server may be a community, a network disk, a multimedia application and so on. The server may be any one in a server cluster of the associated software or website service, and may be also a functional module in a server of the associated software or website service, which is not limited by the embodiment of the disclosure.

A major executive body of the embodiment of the disclosure is the server. Referring to FIG. 2a, the method includes:

Step 201: When receiving a login request carrying account information of a first terminal, the server verifies the account information, and when the account information is verified successfully, creates a data connection with the first terminal,

wherein, the created data connection between the server and the first terminal may be a data connection of different types, such as a General Packet Radio Service (GPRS) connection, and a Wireless Fidelity (WiFi) connection, which is not limited by the embodiment of the disclosure.

Optionally, when receiving the login request carrying the account information, the server verifies the account information, and when the account information is verified successfully, the server creates a long connection with the first terminal. Further a protocol used by the server and the first terminal may be comet, websocket or a user-defined protocol, wherein the comet protocol may apply a long poll mode or a streaming module, which is not limited by the embodiment of the disclosure. Preferably, the protocol used by the server and the first terminal applies the comet protocol under the long poll mode.

Step 202: The server acquires a terminal identifier of the first terminal.

Since a user may use the same account information to login on different terminals in the embodiment of the disclosure, information of one account may correspond to two or more terminals. It is necessary to acquire a terminal identifier of each terminal so as to distinguish terminals corresponding to different account information and two or more terminals corresponding to the same account information.

In the embodiment of the disclosure, a terminal identifier is used for uniquely determining a terminal. Step 202 may be implemented by any one of the following methods.

(1) A terminal number of the first terminal is used as the terminal identifier of the first terminal,

wherein the terminal number may be a device number of the first terminal, a telephone number of the first terminal, or a serial number allocated when the first terminal installs the application, wherein the application is the software or website service associated with the server, and the terminal number may be carried when the first terminal sends the login request to the server. The server may also acquire a terminal number acquisition request to the first terminal and the first terminal further sends the terminal number to the server.

In the embodiment of the disclosure, a host name, an Internet Protocol (IP) address or a Media Access Control (MAC) address of the first terminal may be also used as the terminal identifier of the first terminal, which is not limited by the embodiment of the disclosure.

(2) An identifier is allocated as the terminal identifier of the first terminal.

Optionally, a 64-digit globally unique identifier is generated as the terminal identifier of the first terminal.

Further optionally, the terminal identifier may be generated according to the login time of the first terminal, or the login time of the first terminal and some account information are combined to generate the terminal identifier. For example, the terminal identifier 201310151200 may be generated according to the login time 12:00, Oct. 15, 2013 of the first terminal, or when it is assumed that the account information is 12666666, the terminal identifier 201310151200126 is generated according to the login time and the first three digits of the account information.

It needs to be noted that, Step 202 may be executed when the server receives the login request of the first terminal, and may be also executed after the data connection is created with the first terminal, which is not limited by the embodiment of the disclosure.

Step 203: The server generates data connection information corresponding to the terminal identifier of the account information, and uses the generated data connection information as data connection information corresponding to the first terminal of the account information;

wherein the data connection information includes a connection type, and the time when the data connection is created and so on, and may also include a terminal identifier, an operation record and so on of another terminal connected with the server, which is not limited by the embodiment of the disclosure.

It needs to be noted that when another terminal, such as a third terminal, uses the account information to login, the server also acquires a terminal identifier of the third terminal, and generates data connection information corresponding to the terminal identifier of the third terminal of the account information so that data connection information of the account information may finally include data connection information of a plurality of terminals that use the account information to login.

Step 204: The server acquires a characteristic value of the account information;

wherein, the characteristic value may be the account information itself, and may be also some account information, and may be also a characteristic value acquired by calculating the account information according to a preset algorithm, and so on, which is not limited by the embodiment of the disclosure.

For example, the characteristic value may be the first three digits of the account information, and then the characteristic value of the account information 813025689 is 813. The characteristic value may be also the sum of all digits of the account information, and then the characteristic value of the account information 813025689 is 42.

In practical application, with the development of network technologies and the growth of the number of users, data connection information corresponding to account information having different characteristic values may be stored in different connection databases according to the characteristic values of the account information so that the data connection information according to the account information can be queried subsequently. Therefore, when the data connection information of the account information needs to be queried, a connection database may be determined first through routing, and the data connection information is queried subsequently in the determined connection database, thereby improving the query speed, and rationally allocating the connection databases according to the amount of the account information, and balancing loads of the connection databases.

Step 205: The server queries, according to the characteristic value, pre-created corresponding relations between characteristic values and connection databases, and determines a connection database corresponding to the account information.

Before Step 205, the method further includes: a plurality of connection databases are created in advance, and corresponding relations between characteristic values and the connection databases are created.

For example, the server may create a preset number (such as N) of connection databases in advance according to the number of users: “connection database 1” to “connection database N”. If the characteristic value is the first three digits of the account information, a corresponding relation between the characteristic value and a connection database may be created. For example, it is assumed that a characteristic value in a range of “000 to 099” corresponds to “connection database 1”, a characteristic value in a range of “100 to 199” corresponds to “connection database 2”, a characteristic value in a range of “200 to 299” corresponds to “connection database 3” and so on, then it may be learned that the characteristic value of the account information 813025689 is “813” and the corresponding connection database is “connection database 9”.

Step 206: The server saves the data connection information corresponding to the first terminal of the account information in the connection database corresponding to the account information.

In the embodiment of the disclosure, Step 204 to Step 206 are optional steps which illustrates an example that a plurality of connection databases is created, and the plurality of the connection databases are allocated according to characteristic values of account information. However, as a matter of fact, the connection databases may be also allocated by applying other classification methods. For example, the connection databases are allocated according to levels of the account information and data connection information of different types is saved in corresponding connection databases, or a connection database is created, and all data connection information is saved in the connection database. A method for saving the data connection information is not limited by the embodiment of the disclosure.

207: When receiving an editing operation of the first terminal on multimedia resource information, the server executes the editing operation on the multimedia resource information.

When the first terminal detects that a user has triggered an editing operation on multimedia resource information, the editing operation needs to be sent to the server, and the server executes the editing operation when receiving the editing operation of the first terminal on the multimedia resource information, so as to edit the multimedia resource information.

wherein the multimedia resource information may be a multimedia file, and may be also related information of a multimedia file, such as a playlist in a multimedia application, a multimedia file in a playlist and so on, which is not limited by the embodiment of the disclosure.

Step 208: The server determines whether the editing operation on the multimedia resource information satisfies a preset synchronization condition, and if yes, Step 209 is performed, and the flow is terminated otherwise.

In practical application, the user may have different synchronization requirements on editing operations of different types. For example, the user may expect to synchronize an editing operation on a playlist, and a downloading operation of a text document, but does not expect to synchronize a downloading operation of a movie. Therefore, whether the editing operation on the multimedia resource information satisfies the preset synchronization condition may be determined first, and if yes, synchronization is performed subsequently.

wherein the preset synchronization condition may be preset by the server, a user may also login a terminal to set the preset synchronization condition, which is not limited by the embodiment of the disclosure.

It needs to be noted that the step of determining whether the editing operation on the multimedia resource information satisfies the preset synchronization condition may be executed by the server when the server receives the editing operation on the multimedia resource information, and may be also executed by the first terminal, wherein when the step is executed by the first terminal, that the editing operation on the multimedia resource information satisfies the preset synchronization condition may be represented by a synchronization identifier. Specifically, when detecting that the user has triggered the editing operation on the multimedia resource information, the first terminal determines whether the editing operation satisfies the preset synchronization condition, and if so, adds the synchronization identifier to the editing operation and sends the editing operation to the server so that the server determines that the editing operation on the multimedia resource information satisfies the preset synchronization condition when detecting that the editing operation carries the synchronization identifier.

Further, Step 208 is an optional step. The server may also synchronize all editing operations directly without determining the editing operation, or subsequently determines, according to whether synchronization is allowed by a second terminal, whether synchronization needs to be performed, and so on. A specific method and timing for determining whether synchronization is performed is not limited by the embodiment of the disclosure.

209: The server queries the data connection information corresponding to the account information in the connection database corresponding to the account information.

In the step, the data connection information includes data connection information of at least one logging terminal corresponding to the account information. When any terminal logs out, data connection information of the terminal is deleted or cancelled, so as to ensure the degree of multi-programming of the server.

In the embodiment of the disclosure, creation and closure of a data connection between the server and at least one terminal may be detected in real time by monitoring data connection information globally in real time, so that the data connection information corresponding to the account information can be updated dynamically, and the queried data connection information is data connection information of at least one logging terminal. In addition, the data connection information is queried in the connection database corresponding to the account information, which can reduce the amount of queried data, save the query time and improve the query efficiency.

Step 210: The server determines whether the queried data connection information includes data connection information of a second terminal, and if so, performs Step 211, and otherwise, terminates the flow.

In practical application, the queried data connection information may include data connection information of a plurality of second terminals, then the plurality of second terminals is determined respectively in a subsequent process so as to acquire, through screening, one or more second terminals that need synchronization.

Step 211: The server determines whether the second terminal allows synchronization, and if yes, performs Step 212, and otherwise, terminates the flow.

Optionally, the second terminal may provide a synchronization option, and a user may turn on or turn off the synchronization option to control whether the terminal needs synchronization. When the synchronization option is turned on, it is indicated that the second terminal allows synchronization, and when the synchronization option is turned off, it is indicated that the second terminal prohibits synchronization.

Accordingly, Step 211 includes that the server determines whether the synchronization option of the second terminal is turned on, when detecting that the synchronization option of the second terminal is turned on, determines that the second terminal allows to perform synchronization, and performs Step 212, and when detecting that the synchronization option of the second terminal is turned off, determines that the second terminal does not allow to perform synchronization, and terminates the flow.

In the embodiment of the disclosure, a connection type that allows to perform synchronization may be also preset, so that whether synchronization is necessary may be further determined according to a data connection type of the second terminal even if the second terminal allows synchronization. Synchronization may be performed when the data connection type of the second terminal is the preset connection type.

Accordingly, Step 211 may be replaced by the following step: the server determines, according to the data connection information of the second terminal, whether the data connection type of the second terminal is the preset connection type, and if yes, performs Step 212, and otherwise, terminates the flow.

wherein the preset connection type may be set by the server, and may be also set by the second terminal, which is not limited by the embodiment of the disclosure.

If the second terminal sets the preset connection type as a WiFi connection, that is, when a data connection between the server and the second terminal is a WiFi connection, the second terminal allows to synchronize the editing operation on the first terminal, and when the data connection between the server and the second terminal is not a WiFi connection, the second terminal does not allow to synchronize the editing operation on the first terminal.

In the embodiment of the disclosure, Step 211 may be also replaced by the following step: the server determines whether the second terminal allows to perform synchronization, when the second terminal allows to perform synchronization, the server determines, according to the data connection information of the second terminal, whether the data connection type of the second terminal is the preset connection type, when the data connection type of the second terminal is the preset connection type, performs Step 212, or the server determines, according to the data connection information of the second terminal, whether the data connection type of the second terminal is the preset connection type, when the data connection type of the second terminal is the preset connection type, determines whether the second terminal allows to perform synchronization, and when the second terminal allows to perform synchronization, performs Step 212.

In the embodiment of the disclosure, whether the second terminal allows to perform synchronization and whether the data connection type of the second terminal is the preset connection type are determined, and a terminal that needs to perform synchronization is acquired from terminals corresponding to the account information through screening, thereby saving network resources and improving the synchronization flexibility.

Step 212: The server synchronizes the editing operation on the multimedia resource information to the second terminal.

Optionally, when the server and an associated terminal thereof apply an iPhone Operating System (IOS), the editing operation on the multimedia resource information may be synchronized to the second terminal by applying an Apple Push Notification Service (APNS), so that the synchronization may be also performed when an application installed on the second terminal and associated with the server hibernates.

In the embodiment of the disclosure, the synchronization process is also different for multimedia resource information of different types and different editing operations. Specific synchronization processes will be described below according to illustrated multimedia resource information of several different types.

Step 1: When the multimedia resource information is a playlist, Step 212 includes one of the followings.

Step 1-1: When the editing operation on the multimedia resource information is to create a new playlist, the new playlist is created on the second terminal.

A multimedia application logged in by the first terminal and the second terminal at least includes a default playlist for displaying all multimedia files on the terminals. Besides, one or more new playlists may be also created, and one or more multimedia files on the terminals are added to any one of the new playlists. When a multimedia file in the new playlist is played, it is unnecessary to play all multimedia files, thus playing the multimedia file in a screened manner, wherein one multimedia file may be added to different playlists respectively.

For example, both the first terminal and the second terminal include a default playlist and a playlist A. When the first terminal triggers an operation of creating a new playlist B, that is the editing operation on the multimedia information is to create a new playlist, and a user inputs B as a name of the new playlist, then the server creates the new playlist B on the first terminal, creates a new playlist on the second terminal, and names the new playlist on the second terminal as B.

Step 1-2: When the editing operation on the multimedia resource information is to delete a playlist, the playlist on the second terminal is deleted.

Based on the example of Step 1-1, when the first terminal triggers an operation of deleting the playlist A, the server deletes the playlist A on the first terminal, and deletes the playlist A on the second terminal.

Step 1-3: When the editing operation on the multimedia resource information is to rename a playlist, a new name of the playlist on the first terminal is acquired, and the playlist on the second terminal is renamed as the new name.

Based on the example of Step 1-1, when the first terminal triggers an operation of renaming the playlist A, and inputs a new name C, the server acquires the new name C inputted by the user, renames the playlist A as the playlist C, and renames the playlist A on the second terminal as the playlist C.

Step 1-4: When the editing operation on the multimedia resource information is to add note information to a playlist, the same note information is added to the playlist on the second terminal,

wherein the note information may be comment information of the user, or the playing time or the number of playing times that is generated automatically, and so on, which is not limited by the embodiment of the disclosure.

Based on the example of Step 1-1, when the user adds comment information to the playlist B on the first terminal, the server acquires the comment information, and adds the comment information to the playlist B of the second terminal.

In the embodiment of the disclosure, since the user may play a multimedia file on a plurality of terminals respectively, note information including the playing time, the number of playing times and so on of playing lists will be generated respectively on the plurality of terminals, and the note information including the playing time, the number of playing times and so on generated on the plurality of terminals is synchronized so that the user can acquire playing conditions comprehensively and orderly.

Step 1-5: When the editing operation on the multimedia resource information is to add a multimedia file to a playlist, the multimedia file is added to the playlist on the second terminal,

where, different from downloading a multimedia file, the operation of adding a multimedia file to a playlist refers an operation of adding the multimedia file to the playlist when the multimedia file has been saved on the first terminal and the second terminal.

Based on the example of Step 1-1, when the first terminal triggers an operation of adding a multimedia file “song A” in the default playlist to the playlist A, the server adds “song A” to the playlist A on the first terminal, and adds “song A” to the playlist A on the second terminal.

Step 1-6: When the editing operation on the multimedia resource information is to delete a multimedia file from a playlist, the multimedia file is deleted from the playlist of the second terminal,

wherein different from the operation of deleting a multimedia file on the second terminal, the operation of deleting the multimedia file from the playlist only refers to an operation of deleting the name and other information of the multimedia file from the playlist, that is, the multimedia file is moved out of the playlist without deleting the multimedia file itself.

Based on the example of Step 1-5, when the first terminal triggers an operation of deleting “song a” from the playlist A, the server deletes “song a” from the playlist A of the first terminal while deleting “song a” from the playlist A of the second terminal.

Step 1-7: When the editing operation on the multimedia resource information is to move a multimedia file from a first playlist to a second playlist, the multimedia file is moved from the first playlist to the second playlist on the second terminal.

Based on the example of Step 1-5, when the first terminal triggers an operation of moving “song a” from the playlist A to the playlist B, the server moves “song a” from the playlist A to the playlist B on the first terminal while moving “song a” from the playlist A to the playlist B on the second terminal.

Step 2: The multimedia resource information is at least one multimedia file in a playlist, and Step 212 includes any one of the followings.

Step 2-1: When the editing operation on the multimedia resource information is to download a multimedia file, the multimedia file is downloaded to the second terminal,

wherein, different from an operation of adding a multimedia file to a playlist, the operation of downloading the multimedia file refers to an operation of downloading the multimedia file to the second terminal when the multimedia file is not on the second terminal. Subsequently, a file library may be updated automatically or manually to add the downloaded multimedia file to a default playlist.

For example, the first terminal triggers an operation of downloading a “file b”, then the server downloads the “file b” to a default download folder of the first terminal, and downloads the “file b” to a default download folder of the second terminal.

Step 2-2: When the editing operation on the multimedia resource information is to delete a multimedia file, the multimedia file in the second terminal is deleted,

wherein different from an operation of deleting a multimedia file from a playlist, the operation of deleting the multimedia file refers to an operation of deleting the multimedia file on the second terminal, so as to delete the multimedia file in all playlists where the multimedia file locates.

For example, the first terminal triggers an operation of deleting a “file c”, then the server deletes the “file c” in the first terminal while deleting the “file c” in the second terminal.

In Step 2-1 and Step 2-2, a multimedia file is downloaded or deleted synchronously on different terminals by the server having a wireless connection created with the terminals, and the multimedia file is downloaded or deleted synchronously on different terminals without connecting the first terminal and the second terminal by a data wire, thus implementing a simple, convenient and time-saving operation.

Step 2-3: When the editing operation on the multimedia resource information is to rename a multimedia file, a new name of the multimedia file on the first terminal is acquired, and the multimedia file on the second terminal is renamed as the new name.

Step 2-4: When the editing operation on the multimedia resource information is to add note information to a multimedia file, the same note information is added to the multimedia file on the second terminal,

wherein the note information may be comment information of a user on the multimedia file, or automatically generated information including the playing time, the number of playing times and so on, which is not limited by the embodiment of the disclosure.

Step 2-5: When the editing operation on the multimedia resource information is to modify note information for a multimedia file, the note information of the multimedia file is modified in the same manner on the second terminal.

Based on the example of Step 1-5, when the first terminal triggers an operation of modifying comment information of the “song a” in the playlist A, the server acquires comment information re-inputted by the user, modifies the comment information of the “song a” on the first terminal according to the re-inputted comment information, and modifies the comment information of the “song a” in the playlist A on the second terminal according to the re-inputted comment information.

Step 2-6: When the editing operation on the multimedia resource information is to move a multimedia file from a first folder to a second folder, the multimedia file is moved from the first folder to the second folder on the second terminal.

For example, the terminal moves a “file c” from a “folder x” to a “folder y”, and the “folder x” and the “folder y” are folders associated with the server, then the server moves the “file c” from the “folder x” to the “folder y” on the second terminal.

When the first terminal executes an operation of moving a multimedia file, the same moving operation may be executed on the second terminal to as to facilitate management of multimedia files and implement synchronization of file management.

Step 3: The multimedia resource information is a favorites list and Step 212 includes any one of the followings.

Step 3-1: When the editing operation on the multimedia resource information is to create a new favorites list, the new favorites list is created on the second terminal.

In a multimedia application logged in by the first terminal and the second terminal, a multimedia file may be bookmarked. In other words, an operation of adding the multimedia file to a favorites list is executed, wherein one or more new favorites lists may be created, and one or more multimedia files are added to any new favorites list according to different bookmarks added by a user. A multimedia file may be added to different favorites lists.

If the first terminal triggers an editing operation of creating a new favorites list, the server creates one or more new favorites lists on the first terminal while creating one or more new favorites lists on the second terminal.

For example, when the first terminal triggers an operation of creating a new favorites list B, that is, the editing operation on the multimedia resource information is to create a new favorites list, and a name of the new favorites list, which is inputted by a user, is B, then the server creates the new favorites list B on the first terminal while creating a new favorites list on the second terminal, and naming the favorites list as B.

Step 3-2: When the editing operation on the multimedia resource information is to delete a favorites list, the favorites list on the second terminal is deleted.

Step 3-3: When the editing operation on the multimedia resource information is to rename a favorites list, a new name of the favorites list on the first terminal is acquired, and the favorites list on the second terminal is renamed as the new name.

Step 3-4: When the editing operation on the multimedia resource information is to add note information to a favorites list, the same note information is added to the favorites list on the second terminal.

Step 3-5: When the editing operation on the multimedia resource information is to modify information of a multimedia file in a favorites list, the information of the multimedia file in the favorites list is modified in the same manner on the second terminal.

Step 3-6: When the editing operation on the multimedia resource information is to add a multimedia file to a favorites list, the multimedia file is added to the favorites list on the second terminal.

Step 3-7: When the editing operation on the multimedia resource information is to delete a multimedia file from a favorites list, the multimedia file is deleted from the favorites list on the second terminal,

wherein different from the operation of deleting the multimedia file on the second terminal, the operation of deleting the multimedia file from the favorites list only refers to an operation of deleting a name and other information of the multimedia file from the favorites list. That is, the multimedia file is moved out of the favorites list without deleting the multimedia file itself.

Step 3-8: When the editing operation on the multimedia resource information is to move a multimedia file from a first favorites list to a second favorites list, the multimedia file is moved from the first favorites list to the second favorites list on the second terminal.

Step 4: The multimedia resource information is an interest list for following information of a designated source, and Step 212 includes any one of the followings.

Step 4-1: When the editing operation on the multimedia resource information is to create a new interest list, the new interest list is created on the second terminal.

In the embodiment of the disclosure, a user may follow information of a designated source, such as a multimedia file of a designated singer or a multimedia file of a designated list, and creates an interest list so that the server updates the interest list correspondingly when acquiring new information of the designated source.

For example, the user triggers an operation of following a song of “Wang Fei”, and the server creates a new interest list of “Wang Fei”. When acquiring a new song of “Wang Fei”, the server adds the new song to the interest list. Or, the user triggers an operation of following “daily hit songs”, and the server creates a new interest list of “daily hit songs”. When a new song is added to a list of “daily hit songs”, or an old song is deleted or songs are re-ranked, the server may update the interest list of “daily hit songs”.

If the first terminal triggers an editing operation of creating a new interest list, the server creates one or more new interest lists on the first terminal while creating one or more new interest lists on the second terminal.

For example, when the first terminal triggers an operation of creating a new interest list B, that is, the editing operation on the multimedia resource information is to create a new interest list, and a name of the new interest list, which is inputted by the user, is B, the server creates the new interest list B on the first terminal while creating a new interest list on the second terminal, and renaming the new interest list as B.

Step 4-2: When the editing operation on the multimedia resource information is to delete an interest list, the interest list on the second terminal is deleted.

In the embodiment of the disclosure, the user may further unfollow the information of the designated source. Accordingly, the server deletes the interest list of the designated source.

Step 4-3: When the editing operation on the multimedia resource information is to rename an interest list, a new name of the interest list on the first terminal is acquired, and the interest list on the second terminal is renamed as the new name.

Step 4-4: When the editing operation on the multimedia resource information is to add note information to an interest list, the same note information is added to the interest list on the second terminal.

Step 4-5: When the editing operation on the multimedia resource information is to modify information of a multimedia file in an interest list, the information of the multimedia file in the interest list is modified in the same manner on the second terminal.

According to the method provided by the embodiment of the disclosure, when the editing operation of the first terminal on the multimedia resource information is received, the data connection information corresponding to the account information used by the first terminal is queried; when the queried data connection information includes the data connection information of the second terminal, the editing operation is synchronized to the second terminal, thus implementing real-time synchronization of multimedia resource information of different terminals, good real-time performance, and simple and convenient operations. In addition, the plurality of connection databases is created, and the corresponding relations between the characteristics values and the connection databases are created, and the data connection information of the account information is saved in the connection database corresponding to the characteristic value, thereby saving the query time. Further, the connection databases are allocated rationally according to the amount of account information, thereby balancing the loads of the connection databases.

The method provided by the embodiment of the disclosure may be also implemented by a synchronization system. The synchronization system includes a plurality of units. FIG. 2b is a schematic diagram of a synchronization system framework provided by an embodiment of the disclosure.

Referring to FIG. 2b, a specific matching method of the cells in the synchronization system is as follows.

A login server is configured to authenticate the account information, and when the account information is authenticated successfully, sets the first terminal in a login state based on the account information.

A proxy server is configured to create the data connection with the first terminal, and retain the created data connection, and may be further configured to provide a plurality of communication protocols for the first terminal, and a JavaScript Object Notation (JSON) output format and so on.

An identifier generator is configured to implement Step 206. Specifically, the identifier generator is configured to acquire the terminal identifier of the first terminal.

A memory is configured to implement Step 206. Specifically, the memory is configured to store the data connection information of the account information.

A router, a query server, a connection tracker, a push server and the memory may be configured to implement Step 209 and Step 210. Specifically, the router is configured to determine the connection database corresponding to the account information and send the same to the query server, the query server sends a query message to the push server, the push server sends the query message to the connection tracker to enable the connection tracker to acquire the data connection information of the account information in the memory, and the query server queries whether the data connection information of the account information includes the data connection information of the second terminal.

The push server is further configured to implement Step 212. Specifically, the push server is configured to send a message, and execute the editing operations of the first terminal and the second terminal.

Of course, these units including the login server, the proxy server, the identifier generator, the memory, the router, the query server, the connection tracker, and the push server in the synchronization system may be also matched by other methods. For example, another specific matching method is as follows:

the login server is configured to authenticate the account information, and when the account information is authenticated successfully, sets the first terminal in a login state based on the account information;

the proxy server is configured to create the data connection with the first terminal, and maintain the created data connection, and may be further configured to provide a plurality of communication protocols for the first terminal, and a JSON output format and so on, and use the created data connection to receive the editing operation of the first terminal on the multimedia resource information;

the router is configured to determine the query server that manages the account information in a query server cluster;

the query server queries the locally-stored multimedia resource information corresponding to the account information, executes the editing operation on the multimedia resource information acquired through the query, and sends the editing operation as a synchronous push message to the push server; and

the push server receives the synchronous push message, acquires from the connection tracker, the data connection information corresponding to the account information, determines the connection information of the first terminal data in the acquired data connection information, and sends the synchronous push message to the first terminal according to the data connection information of the first terminal,

wherein the connection tracker is connected with the proxy server, and configured to register or cancel data connection information of a terminal logging in account information, and terminals that have created or closed a data connection with the synchronization system may be tracked in real time by the proxy server; and

the identifier server is configured to acquire, when the connection tracker registers the data connection information of the terminal logging in the account information, a terminal identifier corresponding to the terminal, and the memory is configured to store terminal data connection information containing the terminal identifier, and send a mapping relation of a corresponding storage location of the terminal identifier to the connection tracker.

FIG. 2c is a flowchart of creating a long connection between a proxy server and a terminal according to an embodiment of the disclosure. A major executive body of the process is the proxy server. Referring to FIG. 2c, the process of creating the long connection specifically includes the following steps.

Step 2100: A data connection request of a terminal is received.

Step 2101: A local parameter of the terminal in the data connection request is parsed, and whether the local parameter of the terminal is parsed successfully is determined.

If so, Step 2103 is performed, and otherwise, Step 2102 is performed.

Step 2102: A parameter parsing error packet is returned to the terminal, a connection is closed, and the flow is terminated.

Step 2103: Whether there is information of an account logged in on the terminal is determined.

If so, Step 2105 is performed, and otherwise, Step 2104 is performed.

Step 2104: A non-login packet is returned to the terminal, a connection is closed and the flow is terminated.

Step 2105: Current data connection information corresponding to the terminal of the account information is registered to a connection tracker, and Step 2106 is performed.

Step 2106: If it is determined according to the data connection request that push information needs to be queried for the first time, a push message under the account information is queried through routing on a query server corresponding the account information, and whether the push message is queried successfully is determined.

If so, Step 2107 and Step 2110 are performed, and otherwise, Step 2113 is performed.

Step 2107: Whether a message sent by the terminal based on the account information is received within a preset period of time is detected.

If so, Step 2108 is performed, and otherwise, Step 2111 is performed.

Step 2108: A push message packet is returned to the terminal, and whether the push message packet is returned successfully is determined.

If so, Step 2109 is performed, and otherwise, Step 2113 is performed.

Step 2109: Whether a communication protocol with the terminal is a comet protocol under a long poll mode is determined.

If so, Step 2113 is performed, otherwise, whether the communication protocol with the terminal is a comet protocol under a stream mode is determined, and Step 2107 is performed again.

Step 2110: A connection retention indication field keepalive is sent to the connection tracker, and whether the connection retention indication field keepalive is sent successfully is determined.

If no, Step 2114 is performed, otherwise the long connection with the terminal is created and the flow is terminated.

Step 2111: Whether a communication protocol with the terminal is a comet protocol under a long poll mode is determined.

If so, Step 2112 is performed, and otherwise, Step 2110 is performed.

Step 2112: A timeout packet is returned to the terminal and Step 2113 is performed.

Step 2113: The connection is cancelled, and Step 2114 is performed.

Step 2114: The connection is closed and the flow is terminated.

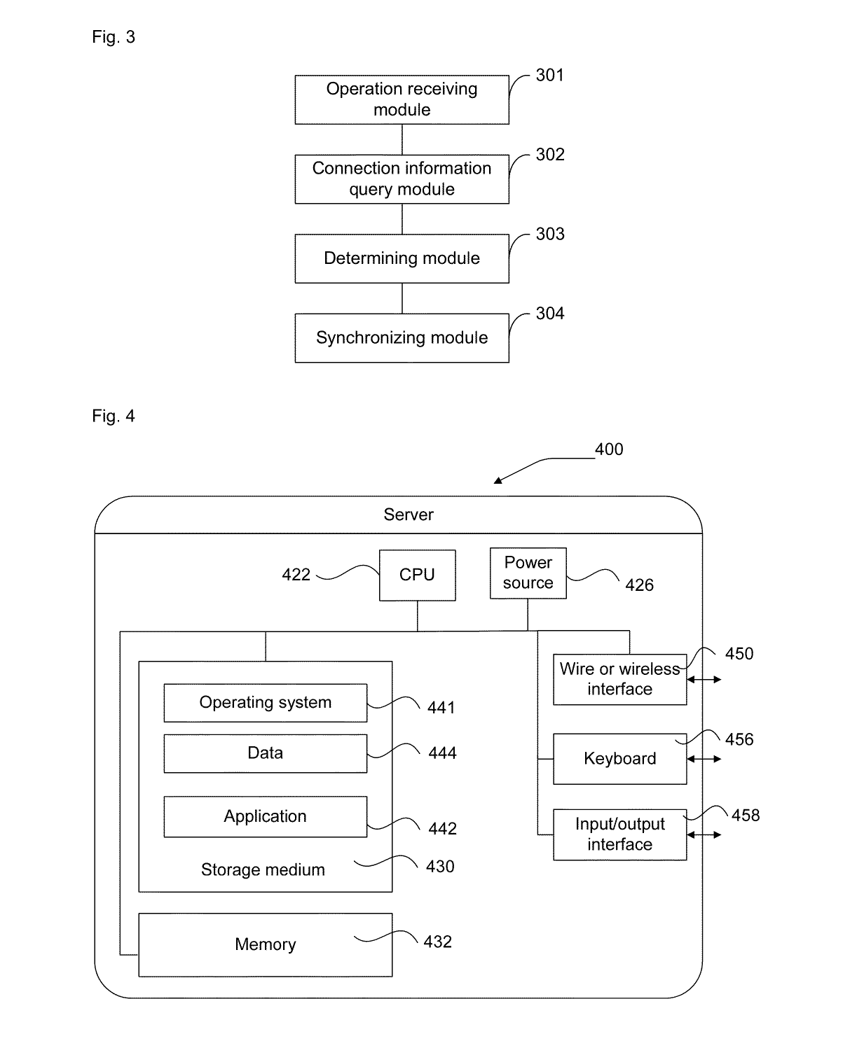

FIG. 3 is a structural diagram of an operation synchronization device provided by an embodiment of the disclosure. Referring to FIG. 3, the device includes an operation receiving module 301, a connection information query module 302, a determining module 303 and a synchronizing module 304,

wherein the operation receiving module 301 is configured to execute, when receiving an editing operation of a first terminal on multimedia resource information, the editing operation on the multimedia resource information; the connection information query module 302 is connected with the operation receiving module 301 and configured to query data connection information corresponding to account information used by the first terminal; the determining module 303 is connected with the connection information query module 302 and configured to determine whether the queried data connection information includes data connection information of a second terminal, and the synchronizing module 304 is connected with the determining module 303 and configured to synchronize, when the queried data connection information includes the data connection information of the second terminal, the editing operation on the multimedia resource information to the second terminal.

Optionally, the device includes:

a synchronization condition determining module configured to determine, after the operation receiving module receives the editing operation of the first terminal on the multimedia resource information, whether the editing operation on the multimedia resource information satisfies a preset synchronization condition;

the connection information query module is specifically configured to query, when the synchronization condition determining module determines that the editing operation on the multimedia resource information satisfies the preset synchronization condition, the data connection information corresponding to the account information used by the first terminal.

Optionally, the synchronizing module 304 is specifically configured to:

when the queried data connection information includes the data connection information of the second terminal, determine whether the second terminal allows to perform synchronization, and when the second terminal allows to perform synchronization, synchronize the editing operation on the multimedia resource information to the second terminal; or

when the queried data connection information includes the data connection information of the second terminal, determine, according to the data connection information of the second terminal, whether a data connection type of the second terminal is a preset connection type, and when the data connection type of the second terminal is the preset connection type, synchronize the editing operation on the multimedia resource information to the second terminal.

Optionally, the multimedia resource information is a playlist, and the synchronizing module 304 includes:

a first playlist synchronizing unit configured to create, when the editing operation on the multimedia resource information is to create a new playlist, the new playlist on the second terminal; or,

a second playlist synchronizing unit configured to delete, when the editing operation on the multimedia resource information is to delete a playlist, the playlist on the second terminal; or,

a third playlist synchronizing unit configured to, when the editing operation on the multimedia resource information is to rename a playlist, acquire a new name of the playlist on the first terminal, and rename the playlist on the second terminal as the new name; or,

a fourth playlist synchronizing unit configured to add, when the editing operation on the multimedia resource information is to add note information to a playlist, the same note information to the playlist on the second terminal; or,

a fifth playlist synchronizing unit configured to add, when the editing operation on the multimedia resource information is to add a multimedia file to a playlist, the multimedia file to the playlist on the second terminal; or,

a sixth playlist synchronizing unit configured to delete, when the editing operation on the multimedia resource information is to delete a multimedia file from a playlist, the multimedia file from the playlist of the second terminal; or,

a seventh playlist synchronizing unit configured to move, when the editing operation on the multimedia resource information is to move a multimedia file from a first playlist to a second playlist, the multimedia file from the first playlist to the second playlist on the second terminal.

Optionally, the multimedia resource information is at least one multimedia file in a playlist, and the synchronizing module 304 includes:

a first file synchronizing unit configured to download, when the editing operation on the multimedia resource information is to download a multimedia file, the multimedia file to the second terminal; or

a second file synchronizing unit configured to delete, when the editing operation on the multimedia resource information is to delete a multimedia file, the multimedia file in the second terminal; or

a third file synchronizing unit configured to, when the editing operation on the multimedia resource information is to rename a multimedia file, acquire a new name of the multimedia file on the first terminal, and rename the multimedia file on the second terminal as the new name; or

a fourth file synchronizing unit configured to add, when the editing operation on the multimedia resource information is to add note information to a multimedia file, add the same note information to the multimedia file on the second terminal; or

a fifth file synchronizing unit configured to modify, when the editing operation on the multimedia resource information is to modify note information for a multimedia file, the note information of the multimedia file in the same manner on the second terminal; or

a sixth file synchronizing unit configured to move, when the editing operation on the multimedia resource information is to move a multimedia file from a first folder to a second folder, the multimedia file from the first folder to the second folder on the second terminal.

Optionally, the multimedia resource information is a favorites list, and the synchronizing module 304 includes:

a first favorites list synchronizing unit configured to create, when the editing operation on the multimedia resource information is to create a new favorites list, the new favorites list on the second terminal; or

a second favorites list synchronizing unit configured to delete, when the editing operation on the multimedia resource information is to delete a favorites list, the favorites list on the second terminal; or

a third favorites list synchronizing unit configured to, when the editing operation on the multimedia resource information is to rename a favorites list, acquire a new name of the favorites list on the first terminal, and rename the favorites list on the second terminal as the new name; or

a fourth favorites list synchronizing unit configured to add, when the editing operation on the multimedia resource information is to add note information to a favorites list, the same note information to the favorites list on the second terminal; or

a fifth favorites list synchronizing unit configured to modify, when the editing operation on the multimedia resource information is to modify information of a multimedia file in a favorites list, the information of the multimedia file in the favorites list in the same manner on the second terminal; or

a sixth favorites list synchronizing unit configured to add, when the editing operation on the multimedia resource information is to add a multimedia file to a favorites list, the multimedia file to the favorites list on the second terminal; or

a seventh favorites list synchronizing unit configured to delete, when the editing operation on the multimedia resource information is to delete a multimedia file from a favorites list, the multimedia file from the favorites list on the second terminal; or

an eighth favorites list synchronizing unit configured to move, when the editing operation on the multimedia resource information is to move a multimedia file from a first favorites list to a second favorites list, the multimedia file from the first favorites list to the second favorites list on the second terminal.

Optionally, the multimedia resource information is an interest list and the synchronizing module 304 includes:

a first interest list synchronizing unit configured to create, when the editing operation on the multimedia resource information is to create a new interest list, the new interest list on the second terminal; or,

a second interest list synchronizing unit configured to delete, when the editing operation on the multimedia resource information is to delete an interest list, the interest list on the second terminal; or,

a third interest list synchronizing unit configured to, when the editing operation on the multimedia resource information is to rename an interest list, acquire a new name of the interest list on the first terminal, and rename the interest list on the second terminal as the new name; or,

a fourth interest list synchronizing unit configured to add, when the editing operation on the multimedia resource information is to add note information to an interest list, the same note information to the interest list on the second terminal; or,

a fifth interest list synchronizing unit configured to modify, when the editing operation on the multimedia resource information is to modify information of a multimedia file in an interest list, the information of the multimedia file in the interest list in the same manner on the second terminal.

Optionally, the device further includes:

a connection creating module configured to create, when a login request carrying the account information of the first terminal is received, a data connection with the first terminal;

a terminal identifier acquiring module, configured to acquire a terminal identifier of the first terminal; and

a connection information generating module, configured to generate data connection information corresponding to the terminal identifier of the account information and use the data connection information as data connection information corresponding to the first terminal of the account information.

Optionally, the terminal identifier acquiring module includes:

a first acquiring unit, configured to use a terminal number of the first terminal as the terminal identifier of the first terminal; or

a second acquiring unit, configured to allocate an identifier as the terminal identifier of the first terminal.

Optionally, the device further includes:

a characteristic value acquiring module, configured to acquire a characteristic value of the account information;

a database determining module configured to query, according to the characteristic value, pre-created corresponding relations between characteristic values and connection databases, and determine a connection database corresponding to the account information; and

a saving module, configured to save the data connection information corresponding to the first terminal of the account information in the connection database corresponding to the account information.

Optionally, the connection information query module is configured to query the data connection information corresponding to the account information in the connection database corresponding to the account information.

According to the device provided by the embodiment of the disclosure, when the editing operation of the first terminal on the multimedia resource information is received, the data connection information corresponding to the account information used by the first terminal is queried; when the queried data connection information includes the data connection information of the second terminal, the editing operation is synchronized to the second terminal, thus implementing real-time synchronization of multimedia resource information of different terminals, good real-time performance, and simple and convenient operations.

It needs to be noted that the operation synchronization device provided by the embodiment above only illustrates division of the functional modules above as an example. In practical application, the functions may be distributed and completed by different functional modules as required. In other words, the internal structure of a server is divided into different functional modules so as to implement all or part of the functions described above. Besides, the operation synchronization device provided by the embodiment above belongs to the same conception of an embodiment of an operation synchronization method, and a specific implementation method of the operation synchronization device provided by the embodiment above is described in details in the embodiment of the method and will not be described repeatedly here.

FIG. 4 is a structural diagram of a server provided by an embodiment of the disclosure. The server 400 may vary significantly due to different configurations or performances, and may include one or more Central Processing Units (CPU) 422 (such as one or more processors), and a memory 432, one or more storage mediums 430 (such as one more mass storage device) for storing an application 442 or data 444, wherein a storage form of the memory 432 and the storage medium 430 may be temporary storage or persistent storage. A program stored in the storage medium 430 may include one or more modules (not shown in the drawings) and each module may include a series of instruction operations in the server. Further, the CPU 422 may be configured to be able to communicate with the storage medium 430, and a series of instruction operations in the storage medium 430 are executed on the CPU 422.

The server 400 may further include one or more power sources 426, one or more wire or wireless network interfaces 450, one or more input/output interfaces 458, one or more keyboards 456, and/or one or more operating systems 441 (such as Windows Server™, Mac OS X™, Unix™, Linux™, FreeBSD™ and so on).

Steps executed by the server in the embodiments of FIG. 1 and FIG. 2a may be executed based on the server as shown in FIG. 4.

Further, an embodiment of the disclosure further provides a storage medium containing a computer executable instruction. The computer executable instruction is used for executing an operation synchronization method when being executed by a computer processor, wherein the method includes that:

when an editing operation of a first terminal on multimedia resource information is received, the editing operation is executed on the multimedia resource information;

data connection information corresponding to account information used by the first terminal is queried;

whether the queried data connection information includes data connection information of a second terminal is determined, and

when the queried data connection information includes the data connection information of the second terminal, the editing operation on the multimedia resource information is synchronized to the second terminal.

When the computer executable instruction is executed by the computer processor, the executed operation synchronization method is not limited by the steps above, and the computer executable instruction may also execute an operation of an operation synchronization method provided by any embodiment of the disclosure.

Those of ordinary skill in the art may understand that all or some steps of the embodiments above may be implemented by hardware, and may be also by related hardware instructed by a program. The program may be stored in a computer readable storage medium. The aforementioned storage medium may be a read-only memory, a magnetic disk or an optical disk and so on.

The above are only preferred embodiments of the disclosure, but are not used for limiting the disclosure. Any modification, equivalent replacement, improvement and so on made within the spirit and principles of the disclosure should be included in the protection scope of the disclosure.

What is claimed is:

1. An operation synchronization method, comprising:
when an editing operation of a first terminal on multimedia resource information is received, executing the editing operation on the multimedia resource information;
querying data connection information corresponding to account information used by the first terminal;
determining whether the queried data connection information comprises data connection information of a second terminal, and
when the queried data connection information comprises the data connection information of the second terminal, synchronizing the editing operation on the multimedia resource information to the second terminal.

2. The method according to claim 1, wherein the step of when the queried data connection information comprises the data connection information of the second terminal, synchronizing the editing operation on the multimedia resource information to the second terminal comprises:
when the queried data connection information comprises the data connection information of the second terminal, synchronizing the editing operation on the multimedia resource information to the second terminal by creating a long connection with the second terminal.

3. The method according to claim 1, wherein after the editing operation of the first terminal on the multimedia resource information is received, the method further comprises:
determining whether the editing operation on the multimedia resource information satisfies a preset synchronization condition, and when the editing operation on the multimedia resource information satisfies the preset synchronization condition, executing the step of querying the data connection information corresponding to the account information used by the first terminal.

4. The method according to claim 1, wherein the step of when the queried data connection information comprises the data connection information of the second terminal, synchronizing the editing operation on the multimedia resource information to the second terminal comprises:
when the queried data connection information comprises the data connection information of the second terminal, determining whether the second terminal allows to perform synchronization, and when the second terminal allows to perform synchronization, executing the step of synchronizing the editing operation on the multimedia resource information to the second terminal; or
when the queried data connection information comprises the data connection information of the second terminal, determining whether a data connection type of the second terminal is a preset connection type according to the data connection information of the second terminal, and when the data connection type of the second terminal is the preset connection type, executing the step of synchronizing the editing operation on the multimedia resource information to the second terminal.

5. The method according to claim 1, wherein the multimedia resource information is a playlist, and synchronizing the editing operation on the multimedia resource information to the second terminal comprises:
when the editing operation on the multimedia resource information is to create a new playlist, creating the new playlist on the second terminal; or
when the editing operation on the multimedia resource information is to delete a playlist, deleting the playlist on the second terminal; or
when the editing operation on the multimedia resource information is to rename a playlist, acquiring a new name of the playlist on the first terminal, and renaming the playlist on the second terminal as the new name; or
when the editing operation on the multimedia resource information is to add note information to a playlist, adding the same note information to the playlist on the second terminal; or
when the editing operation on the multimedia resource information is to add a multimedia file to a playlist, adding the multimedia file to the playlist on the second terminal; or
when the editing operation on the multimedia resource information is to delete a multimedia file from a playlist, deleting the multimedia file from the playlist of the second terminal; or
when the editing operation on the multimedia resource information is to move a multimedia file from a first playlist to a second playlist, moving the multimedia file from the first playlist to the second playlist on the second terminal.

6. The method according to claim 1, wherein the multimedia resource information is at least one multimedia file in a playlist, and synchronizing the editing operation on the multimedia resource information to the second terminal comprises:
when the editing operation on the multimedia resource information is to download a multimedia file, downloading the multimedia file to the second terminal; or
when the editing operation on the multimedia resource information is to delete a multimedia file, deleting the multimedia file in the second terminal; or
when the editing operation on the multimedia resource information is to rename a multimedia file, acquiring a new name of the multimedia file on the first terminal, and renaming the multimedia file on the second terminal as the new name; or
when the editing operation on the multimedia resource information is to add note information to a multimedia file, adding the same note information to the multimedia file on the second terminal; or
when the editing operation on the multimedia resource information is to modify note information for a multimedia file, modifying the note information of the multimedia file in the same manner on the second terminal; or
when the editing operation on the multimedia resource information is to move a multimedia file from a first folder to a second folder, moving the multimedia file from the first folder to the second folder on the second terminal.

7. The method according to claim 1, wherein the multimedia resource information is a favorites list, and synchronizing the editing operation on the multimedia resource information to the second terminal comprises:
when the editing operation on the multimedia resource information is to create a new favorites list, creating the new favorites list on the second terminal; or
when the editing operation on the multimedia resource information is to delete a favorites list, deleting the favorites list on the second terminal; or
when the editing operation on the multimedia resource information is to rename a favorites list, acquiring a new name of the favorites list on the first terminal, and renaming the favorites list on the second terminal as the new name; or
when the editing operation on the multimedia resource information is to add note information to a favorites list, adding the same note information to the favorites list on the second terminal; or
when the editing operation on the multimedia resource information is to modify information of a multimedia file in a favorites list, modifying the information of the multimedia file in the favorites list in the same manner on the second terminal; or
when the editing operation on the multimedia resource information is to add a multimedia file to a favorites list, adding the multimedia file to the favorites list on the second terminal; or
when the editing operation on the multimedia resource information is to delete a multimedia file from a favorites list, deleting the multimedia file from the favorites list on the second terminal; or
when the editing operation on the multimedia resource information is to move a multimedia file from a first favorites list to a second favorites list, moving the multimedia file from the first favorites list to the second favorites list on the second terminal.

8. The method according to claim 1, wherein the multimedia resource information is an interest list for following information of a designated source, and synchronizing the editing operation on the multimedia resource information to the second terminal comprises:
when the editing operation on the multimedia resource information is to create a new interest list, creating the new interest list on the second terminal; or
when the editing operation on the multimedia resource information is to delete an interest list, deleting the interest list on the second terminal; or
when the editing operation on the multimedia resource information is to rename an interest list, acquiring a new name of the interest list on the first terminal, and renaming the interest list on the second terminal as the new name; or
when the editing operation on the multimedia resource information is to add note information to an interest list, adding the same note information to the interest list on the second terminal; or
when the editing operation on the multimedia resource information is to modify information of a multimedia file in an interest list, modifying the information of the multimedia file in the interest list in the same manner on the second terminal.

9. The method according to claim 1, wherein the method further comprises:
when a login request carrying the account information of the first terminal is received, creating a data connection with the first terminal;
acquiring a terminal identifier of the first terminal; and
generating data connection information corresponding to the terminal identifier of the account information and using the data connection information as data connection information corresponding to the first terminal of the account information.

10. The method according to claim 9, wherein acquiring the terminal identifier of the first terminal comprises:
using a terminal number of the first terminal as the terminal identifier of the first terminal; or
allocating an identifier as the terminal identifier of the first terminal.

11. The method according to claim 9, wherein the method further comprises:
acquiring a characteristic value of the account information;
querying, according to the characteristic value, pre-created corresponding relations between characteristic values and connection databases, and determining a connection database corresponding to the account information; and
saving the data connection information corresponding to the first terminal of the account information in the connection database corresponding to the account information.

12. The method according to claim 11, wherein querying the data connection information corresponding to the account information used by the first terminal comprises:
querying the data connection information corresponding to the account information in the connection database corresponding to the account information.

13. An operation synchronization device, comprising:
an operation receiving module configured to execute, when receiving an editing operation of a first terminal on multimedia resource information, the editing operation on the multimedia resource information;
a connection information query module, configured to query data connection information corresponding to account information used by the first terminal;
a determining module, configured to determine whether the queried data connection information comprises data connection information of a second terminal, and
a synchronizing module, configured to synchronize, when the queried data connection information comprises the data connection information of the second terminal, the editing operation on the multimedia resource information to the second terminal.

14. The device according to claim 13, wherein the synchronizing module is specifically configured to synchronize, when the queried data connection information comprises the data connection information of the second terminal, the editing operation on the multimedia resource information to the second terminal by creating a long connection with the second terminal.

15. The device according to claim 13, wherein the device further comprises:
a synchronization condition determining module configured to determine, after the operation receiving module receives the editing operation of the first terminal on the multimedia resource information, whether the editing operation on the multimedia resource information satisfies a preset synchronization condition;
the connection information query module is specifically configured to query, when the synchronization condition determining module determines that the editing operation on the multimedia resource information satisfies the preset synchronization condition, the data connection information corresponding to the account information used by the first terminal.

16. The device according to claim 13, wherein the synchronizing module is specifically configured to:
when the queried data connection information comprises the data connection information of the second terminal, determine whether the second terminal allows to perform synchronization, and when the second terminal allows to perform synchronization, synchronize the editing operation on the multimedia resource information to the second terminal; or
when the queried data connection information comprises the data connection information of the second terminal, determine whether a data connection type of the second terminal is a preset connection type according to the data connection information of the second terminal, and when the data connection type of the second terminal is the preset connection type, synchronize the editing operation on the multimedia resource information to the second terminal.

17. The device according to claim 13, wherein the multimedia resource information is a playlist, and the synchronizing module comprises:
a first playlist synchronizing unit configured to create, when the editing operation on the multimedia resource information is to create a new playlist, the new playlist on the second terminal; or
a second playlist synchronizing unit configured to delete, when the editing operation on the multimedia resource information is to delete a playlist, the playlist on the second terminal; or
a third playlist synchronizing unit configured to, when the editing operation on the multimedia resource information is to rename a playlist, acquire a new name of the playlist on the first terminal, and rename the playlist on the second terminal as the new name; or
a fourth playlist synchronizing unit configured to add, when the editing operation on the multimedia resource information is to add note information to a playlist, the same note information to the playlist on the second terminal; or
a fifth playlist synchronizing unit configured to add, when the editing operation on the multimedia resource information is to add a multimedia file to a playlist, the multimedia file to the playlist on the second terminal; or
a sixth playlist synchronizing unit configured to delete, when the editing operation on the multimedia resource information is to delete a multimedia file from a playlist, the multimedia file from the playlist of the second terminal; or
a seventh playlist synchronizing unit configured to move, when the editing operation on the multimedia resource information is to move a multimedia file from a first playlist to a second playlist, the multimedia file from the first playlist to the second playlist on the second terminal.

18. The device according to claim 13, wherein the multimedia resource information is at least one multimedia file in a playlist, and the synchronizing module comprises:
a first file synchronizing unit configured to download, when the editing operation on the multimedia resource information is to download a multimedia file, the multimedia file to the second terminal; or
a second file synchronizing unit configured to delete, when the editing operation on the multimedia resource information is to delete a multimedia file, the multimedia file in the second terminal; or
a third file synchronizing unit configured to, when the editing operation on the multimedia resource information is to rename a multimedia file, acquire a new name of the multimedia file on the first terminal, and rename the multimedia file on the second terminal as the new name; or
a fourth file synchronizing unit configured to add, when the editing operation on the multimedia resource information is to add note information to a multimedia file, add the same note information to the multimedia file on the second terminal; or
a fifth file synchronizing unit configured to modify, when the editing operation on the multimedia resource information is to modify note information for a multimedia file, the note information of the multimedia file in the same manner on the second terminal; or
a sixth file synchronizing unit configured to move, when the editing operation on the multimedia resource information is to move a multimedia file from a first folder to a second folder, the multimedia file from the first folder to the second folder on the second terminal.

19. The device according to claim 13, wherein the multimedia resource information is a favorites list, and the synchronizing module comprises:
a first favorites list synchronizing unit configured to create, when the editing operation on the multimedia resource information is to create a new favorites list, the new favorites list on the second terminal; or
a second favorites list synchronizing unit configured to delete, when the editing operation on the multimedia resource information is to delete a favorites list, the favorites list on the second terminal; or
a third favorites list synchronizing unit configured to, when the editing operation on the multimedia resource information is to rename a favorites list, acquire a new name of the favorites list on the first terminal, and rename the favorites list on the second terminal as the new name; or
a fourth favorites list synchronizing unit configured to add, when the editing operation on the multimedia resource information is to add note information to a favorites list, the same note information to the favorites list on the second terminal; or
a fifth favorites list synchronizing unit configured to modify, when the editing operation on the multimedia resource information is to modify information of a multimedia file in a favorites list, the information of the multimedia file in the favorites list in the same manner on the second terminal; or
a sixth favorites list synchronizing unit configured to add, when the editing operation on the multimedia resource information is to add a multimedia file to a favorites list, the multimedia file to the favorites list on the second terminal; or
a seventh favorites list synchronizing unit configured to delete, when the editing operation on the multimedia resource information is to delete a multimedia file from a favorites list, the multimedia file from the favorites list on the second terminal; or
an eighth favorites list synchronizing unit configured to move, when the editing operation on the multimedia resource information is to move a multimedia file from a first favorites list to a second favorites list, the multimedia file from the first favorites list to the second favorites list on the second terminal.

20. The device according to claim 13, wherein the multimedia resource information is an interest list and the synchronizing module comprises:
a first interest list synchronizing unit configured to create, when the editing operation on the multimedia resource information is to create a new interest list, the new interest list on the second terminal; or
a second interest list synchronizing unit configured to delete, when the editing operation on the multimedia resource information is to delete an interest list, the interest list on the second terminal; or
a third interest list synchronizing unit configured to, when the editing operation on the multimedia resource information is to rename an interest list, acquire a new name of the interest list on the first terminal, and rename the interest list on the second terminal as the new name; or
a fourth interest list synchronizing unit configured to add, when the editing operation on the multimedia resource information is to add note information to an interest list, the same note information to the interest list on the second terminal; or
a fifth interest list synchronizing unit configured to modify, when the editing operation on the multimedia resource information is to modify information of a multimedia file in an interest list, the information of the multimedia file in the interest list in the same manner on the second terminal.

21. The device according to claim 13, wherein the device further comprises:
a connection creating module configured to create, when a login request carrying the account information of the first terminal is received, a data connection with the first terminal;
a terminal identifier acquiring module, configured to acquire a terminal identifier of the first terminal; and
a connection information generating module, configured to generate data connection information corresponding to the terminal identifier of the account information and use the data connection information as data connection information corresponding to the first terminal of the account information.

22. The device according to claim 21, wherein the terminal identifier acquiring module comprises:
a first acquiring unit, configured to use a terminal number of the first terminal as the terminal identifier of the first terminal; or
a second acquiring unit, configured to allocate an identifier as the terminal identifier of the first terminal.

23. The device according to claim 21, wherein the device further comprises:
a characteristic value acquiring module, configured to acquire a characteristic value of the account information;
a database determining module configured to query, according to the characteristic value, pre-created corresponding relations between characteristic values and connection databases, and determine a connection database corresponding to the account information; and
a saving module, configured to save the data connection information corresponding to the first terminal of the account information in the connection database corresponding to the account information.

24. The device according to claim 23, wherein the connection information query module is specifically configured to: query the data connection information corresponding to the account information in the connection database corresponding to the account information.

25. A storage medium comprising computer executable instructions, the computer executable instructions being used for executing an operation synchronization method when being executed by a computer processor, wherein the method comprises:
when an editing operation of a first terminal on multimedia resource information is received, executing the editing operation on the multimedia resource information;
querying data connection information corresponding to account information used by the first terminal;
determining whether the queried data connection information comprises data connection information of a second terminal, and
when the queried data connection information comprises the data connection information of the second terminal, synchronizing the editing operation on the multimedia resource information to the second terminal.
